(19) United States
(12) Patent Application Publication
(10) Pub. No.: US 2016/0349947 A1
(43) Pub. Date: Dec. 1, 2016

(54) METHOD AND DEVICE FOR SENDING MESSAGE

(71) Applicant: Xiaomi Inc., Beijing (CN)

(72) Inventors: Fei XIANGLI, Beijing (CN); Shengbo CHENG, Beijing (CN); Baoke CHEN, Beijing (CN)

(73) Assignee: Xiaomi Inc.

(21) Appl. No.: 15/161,979

(22) Filed: May 23, 2016

(30) Foreign Application Priority Data
May 29, 2015 (CN) 201510290442.9

(51) Int. Cl. G06F 3/0482; G06F 3/0488; G06F 3/0484; H04W 4/12; H04L 12/58

(52) U.S. Cl. CPC G06F 3/0482; H04W 4/12; H04L 51/02; G06F 3/04842; G06F 3/04883

(57) ABSTRACT

A method for sending a message from a terminal includes detecting a triggering event with respect to a sending button in a message interface of the terminal and determining a condition that the triggering event satisfies. If the determined condition that the triggering event satisfies is a first condition for sending a common phrase, a corresponding common phrase corresponding to the sending button is acquired and sent. If the determined condition that the triggering event satisfies is a second condition for sending an inputted message, content in a message input box in the message interface is acquired and sent.

### CROSS-REFERENCE TO RELATED APPLICATIONS

The present application is based upon and claims priority to Chinese Patent Application No. 201510290442.9 filed May 29, 2015, the entire contents of which are incorporated herein by reference.

### TECHNICAL FIELD

The present disclosure relates to communication technology and, more particularly, to a method and device for sending a message.

### BACKGROUND

In conventional technologies, when a mobile phone receives a short message sent from a sending party, the short message is displayed in a short-message displaying interface, which contains a short-message input box and a sending button. To reply to the sending party, the user of the mobile phone inputs a reply message in the short-message input box, and clicks the sending button. Upon detection of a sending command triggered by the user clicking the sending button, the mobile phone acquires the reply message in the short-message input box and forwards the reply message to the party sending the short message.

### SUMMARY

In accordance with the present disclosure, there is provided a method for sending a message from a terminal. The method includes detecting a triggering event with respect to a sending button in a message interface of the terminal and determining a condition that the triggering event satisfies. If the determined condition that the triggering event satisfies is a first condition for sending a common phrase, a corresponding common phrase corresponding to the sending button is acquired and sent. If the determined condition that the triggering event satisfies is a second condition for sending an inputted message, content in a message input box in the message interface is acquired and sent.

Also in accordance with the present disclosure, there is provided a terminal including a processor and a memory storing instructions that, when executed by the processor, cause the processor to detect a triggering event with respect to a sending button in a message interface of the terminal and determine a condition that the triggering event satisfies. If the determined condition that the triggering event satisfies is a first condition for sending a common phrase, the instructions cause the processor to acquire a corresponding common phrase corresponding to the sending button and send the corresponding common phrase. If the determined condition that the triggering event satisfies is a second condition for sending an inputted message, the instructions cause the processor to acquire content in a message input box in the message interface and send the content.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for sending a message according to an exemplary embodiment.

FIG. 2A is a flow chart illustrating a method for sending a message according to another exemplary embodiment.

FIG. 2B is a schematic diagram illustrating a message interface according to an exemplary embodiment.

FIG. 3A is a block diagram of a device for sending a message according to an exemplary embodiment.

FIG. 3B is a block diagram of a first determining module in FIG. 3A according to an exemplary embodiment.

FIG. 3C is a block diagram of a device for sending a message according to another exemplary embodiment.

FIG. 3D is a block diagram of a device for sending a message according to another exemplary embodiment.

FIG. 3E is a block diagram of a device for sending a message according to another exemplary embodiment.

FIG. 3F is a block diagram of a device for sending a message according to another exemplary embodiment.

FIG. 4 is a block diagram of a device for sending a message according to another exemplary embodiment.

Through the above accompanying drawings, the specific embodiments of the present disclosure have been shown, for which a more detailed description will be given as below. These drawings and textual description are not intended to limit the scope of the concept of the present disclosure in any manner, but to explain the concept of the present disclosure to those skilled in the art through particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the invention as recited in the appended claims.

According to the present disclosure, common phrases can be set for a user. A common phrase can be a phrase that the user frequently uses when sending short messages. For example, a message with a sending frequency higher than a preset threshold can be defined as a common phrase of the user. A common phrase can be quickly sent according to a manner consistent with the present disclosure, such as described below.

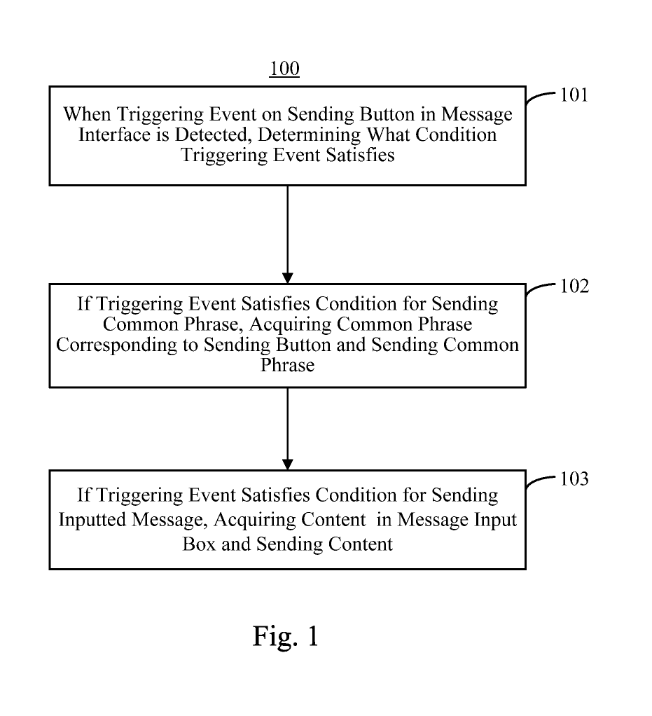

FIG. 1 is a flow chart illustrating a method 100 for sending a message according to an exemplary embodiment. The method 100 can be implemented, for example, in a mobile terminal. As shown in FIG. 1, at 101, when a triggering event of a sending button in a message interface is detected, a condition that the triggering event satisfies is determined. At 102, if it is determined that the triggering event satisfies a condition for sending a common phrase, a common phrase corresponding to the sending button is acquired and sent. The common phrase was preset corresponding to the sending button. At 103, if it is determined that the triggering event satisfies a condition for sending an inputted message, content in a message input box is acquired and sent.

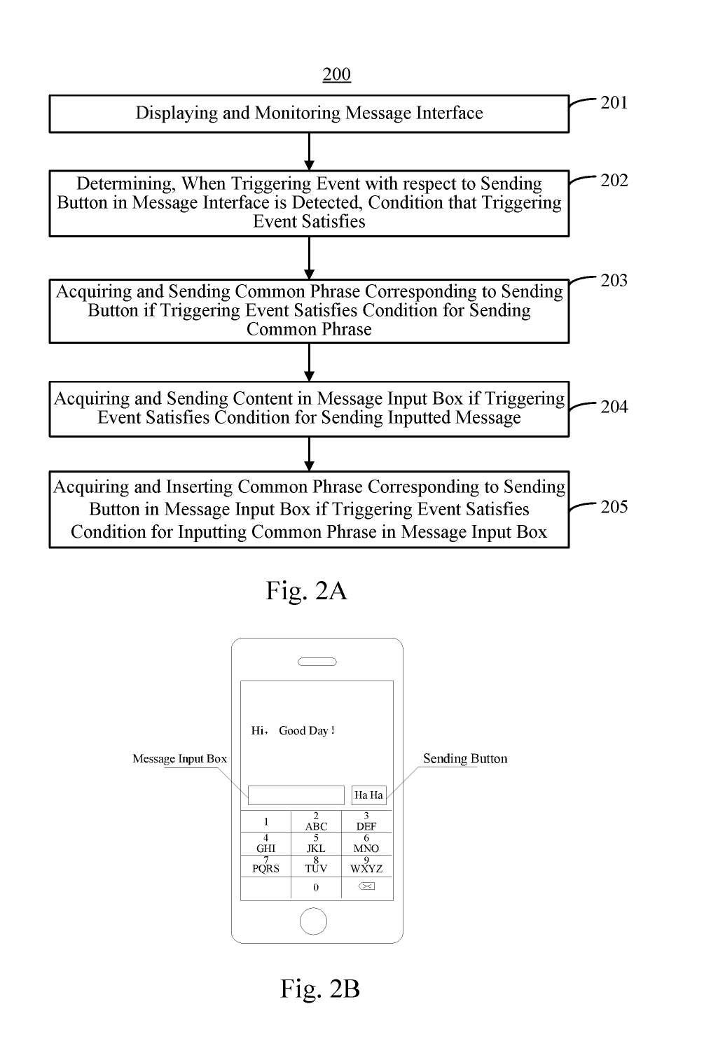

FIG. 2A is a flow chart illustrating a method 200 for sending a message according to another exemplary embodiment. The method 200 can be implemented, for example, in a mobile terminal. As shown in FIG. 2A, at 201, a message interface is displayed and monitored.

FIG. 2B schematically shows a message interface consistent with the present disclosure, which includes a sending button, a message input box, and a display area displaying a received message sent from a sending party. The message interface can be, for example, a short message interface, a multimedia message interface, an instant chatting interface, or the like, and the message can be, for example, a short message, a multimedia message, an instant message, or the like.

In some embodiments, the sending button can correspond to at least one common phrase. A common phrase is a message frequently sent by the user, such as a message with a sending frequency higher than a preset threshold. For example, messages such as “Have you arrived at home?” and “Have you had a meal?” which are frequently sent by the user can be defined as common phrases.

A common phrase corresponding to the sending button can be previously set by the user. For example, the user can select a message in the message interface, and perform an acquiring operation on the selected message to set the message as a common phrase corresponding to the sending button. More specifically, when a trigger operation of a selected message in the message interface is detected, the trigger operation is acquired and analyzed. If the trigger operation is the acquiring operation, the message, for which the trigger operation is performed, is acquired as a common phrase and set as corresponding to the sending button. The acquiring operation can be, for example, a long press operation, a double click operation, or the like.

As described above, the sending button can correspond to one or more common phrases. In some embodiments, the sending button can only correspond to one common phrase. When a new common phrase is acquired, if an existing common phrase has already been associated with the sending button, the existing common phrase corresponding to the sending button is replaced with the newly acquired common phrase. If the sending button does not have a corresponding common phrase, the newly acquired common phrase is set as corresponding to the sending button. In some embodiments, the sending button can correspond to more than one common phrase. When a new common phrase is acquired, if an existing common phrase has already been associated with the sending button, the newly acquired common phrase is additionally set as corresponding to the sending button. If the sending button does not have a corresponding common phrase, the acquired common phrase is set as corresponding to the sending button.

In addition to setting a common phrase corresponding to the sending button by the user as described above, other manners can also be utilized. In some embodiments, the mobile terminal can automatically set a common phrase as corresponding to the sending button. For example, the mobile terminal can acquire sending frequencies of messages sent by the user, acquire a message with a sending frequency satisfying a preset condition as a common phrase, and set the acquired common phrase as corresponding to the sending button.

If the sending button can only correspond to one common phrase, a message with a highest sending frequency can be acquired as a common phrase. If the sending button can correspond to more than one common phrase, a preset number of messages with highest sending frequencies can be taken as common phrases or messages with sending frequencies each higher than a frequency threshold.

When the user performs a trigger operation of the sending button in the message interface, a triggering event with respect to the sending button will be generated. The mobile terminal monitors the message interface, and when it detects that a triggering event with respect to the sending button is generated, the mobile terminal determines the condition that the triggering event satisfies (202 in FIG. 2).

According to the present disclosure, the conditions that the triggering event can satisfy include, for example, a condition for sending a common phrase, also referred to herein as a “common phrase sending condition,” a condition for sending an inputted message, also referred to herein as an “inputted message sending condition,” and a condition for inserting a common phrase, also referred to herein as an “inserting condition.” As will be described in more detail below, when the common phrase sending condition is satisfied, depending on the trigger operation, a common phrase corresponding to the sending button is sent directly or is combined with content in the message input box and then the combined message is sent. When the inputted message sending condition is satisfied, the content in the message input box is sent directly. When the inserting condition is satisfied, a common phrase corresponding to the sending button is inserted into the message input box. According to the present disclosure, different approaches can be used in determining what condition is satisfied, as described in more detail below.

For example, in some embodiments, to determine what condition the triggering event satisfies, the mobile terminal can determine whether content has been inputted to the message input box of the message interface before the triggering event is generated, and whether the sending button corresponds to a common phrase. If no content has been inputted to the message input box before the triggering event is generated and the sending button corresponds to a common phrase, then it is determined that the triggering event satisfies the common phrase sending condition. On the other hand, if content has been inputted to the message input box before the triggering event is generated and the sending button does not correspond to any common phrase, then it is determined that the triggering event satisfies the inputted message sending condition.

Alternatively, the mobile terminal can determine what condition the triggering event satisfies according to the type of a trigger operation performed by the user with respect to the sending button. According to the present disclosure, the trigger operation may be one of a normal operation, a preset first operation, a preset second operation, and a preset third operation. The normal operation is configured to trigger the mobile terminal to directly send the inputted message in the message input box, and is also referred herein as an “inputted message sending operation.” The first operation is configured to trigger the mobile terminal to directly send a common phrase corresponding to the sending button, and is also referred to herein as a “common phrase sending operation.” The second operation is configured to trigger the mobile terminal to insert a common phrase corresponding to the sending button into the message input box and send the content that is currently in the message input box, including the inserted common phrase, and is also referred to herein as a “common phrase inserting and sending operation.” The third operation is configured to trigger the mobile terminal to merely insert a common phrase corresponding to the sending button into the message input box, and is also referred to herein as a “common phrase inserting operation.”

In this exemplary approach, if the trigger operation is the normal operation and a common phrase corresponds to the sending button, then it is determined that the triggering event satisfies the inputted message sending condition. If the trigger operation is the first operation or the second operation, and a common phrase corresponds to the sending button, then it is determined that the triggering event satisfies the common phrase sending condition. If the trigger operation is the third operation and a common phrase corresponds to the sending button, then it is determined that the triggering event satisfies the inserting condition.

In some embodiments, the normal operation, the first operation, the second operation, and the third operation can be selected from, for example, the following operations: a single click operation, a long press operation, a slide operation, a double click operation. For example, the first operation can be the single click operation, the second operation can be the long press operation or the slide operation, and the third operation can be the double click operation. The normal operation, the first operation, the second operation, and the third operation can be different from each other.

In some embodiments, the normal operation and the first operation can include the same operation, such as the single click operation. In this scenario, whether the trigger operation is the normal operation or the first operation depends on whether content has been inputted into the message input box. For example, when the mobile terminal receives a single click operation, if content has been inputted into the message input box, the mobile terminal determines that the trigger operation is the normal operation, and that the triggering event satisfies the inputted message sending condition. On the other hand, if the message input box does not contain any content, the mobile terminal determines that the trigger operation is the first operation, and that the triggering event satisfies the common phrase sending condition.

At 203, if it is determined that the triggering event satisfies the common phrase sending condition, a common phrase corresponding to the sending button is acquired and sent. If the sending button corresponds to only one common phrase, the common phrase can be directly acquired and sent to the receiving party, e.g., a party currently communicating with the user. If the sending button corresponds to a plurality of common phrases, one of the common phrases can be acquired and sent to the receiving party, for example, according to the methods described below.

First, a searching condition is acquired, which includes at least one of a current time, intimacy between the user of the mobile terminal and the receiving party, and a friend group to which the receiving party belongs. A common phrase best matching the searching condition is chosen from the common phrases corresponding to the sending button and sent to the receiving party.

In some embodiments, each common phrase can be assigned a corresponding matching condition. The matching condition of a common phrase can include, for example, an applicable time period, a friend group, and an applicable intimacy level. For example, a common phrase “Have you had a meal?” generally has an applicable time period from 12:00 pm to 1:00 pm or from 7:00 pm to 9:00 pm. Some common phrases with intimacy expressions, such as “What are you doing now, darling?”, are usually applicable to a family member or an intimate friend of the user, and therefore such common phrases are applicable to a family group, and have a relatively high intimacy level.

In order to improve user experience, a common phrase can be acquired and displayed on the sending button before the user performs a trigger operation on the sending button. The common phrase displayed on the sending button can be directly acquired and sent.

In some embodiments, if the sending button corresponds to only one common phrase, the common phrase can be directly acquired and displayed on the sending button. If the sending button corresponds to a plurality of common phrases, each common phrase is matched with the searching condition to obtain a matching degree between that common phrase and the searching condition. The common phrase with the highest matching degree is displayed on the sending button. In some embodiments, the searching condition includes at least one of a current time, intimacy between the user of the terminal and the receiving party, and a friend group to which the receiving party belongs.

As described above, a triggering event involving either the first operation or the second operation could satisfy the common phrase sending condition. If the triggering event satisfies the common phrase sending condition and the corresponding trigger operation is the first operation, then the common phrase is acquired and sent directly. On the other hand, if the triggering event satisfies the common phrase sending condition and the corresponding trigger operation is the second operation, then the common phrase is acquired and inserted at a cursor position in the message input box, and then the entire content in the message input box (including the common phrase) is sent. In some scenarios, the message input box does not contain any previously-inputted content, and then the effect of the second operation would be the same as the first operation, i.e., sending only the common phrase.

At 204, if it is determined that the triggering event satisfies the inputted message sending condition, content already in the message input box is acquired and sent, without a common phrase being further inserted into the message input box.

At 205, if it is determined that the triggering event satisfies the inserting condition, a common phrase corresponding to the sending button is acquired and inserted in the message input box of the message interface. After the common phrase is inserted into the message input box, it can be considered to become a part of the inputted message. The user can continue to input content into the message input box or perform other operations with respect to the sending button. For example, if the user then wishes to send the content in the message input box, the user can perform the normal operation to directly send the content in the message input box.

In the examples described above, it is assumed that the default common phrase is the common phrase that the user wishes to send. However, in some embodiments, if the sending button corresponds to a plurality of common phrases and the common phrase displayed on the sending button is not the one the user wishes to send, the user can perform a fourth operation on the sending button to trigger the display of other common phrases corresponding to the sending button. The fourth operation is also referred to herein as a “displaying operation.” The fourth operation can be, for example, a long press operation, an upward slide operation, a circling operation, or the like. Then, the user can select a common phrase from the plurality of common phrases and perform a trigger operation with respect to the selected common phrase.

That is, if an acquired trigger operation of the sending button is the preset fourth operation, common phrases corresponding to the sending button are displayed. When it is detected that a trigger operation with respect to one of the common phrases is performed, the condition that the trigger operation satisfies is determined, and a corresponding action is performed, according to one of the exemplary methods described above in connection with FIGS. 1 and 2.

Hereinafter, exemplary devices consistent with embodiments of the present disclosure are disclosed. These devices are configured to perform methods of the present disclosure. Detailed operations of these devices are similar to the methods described above, and are thus omitted.

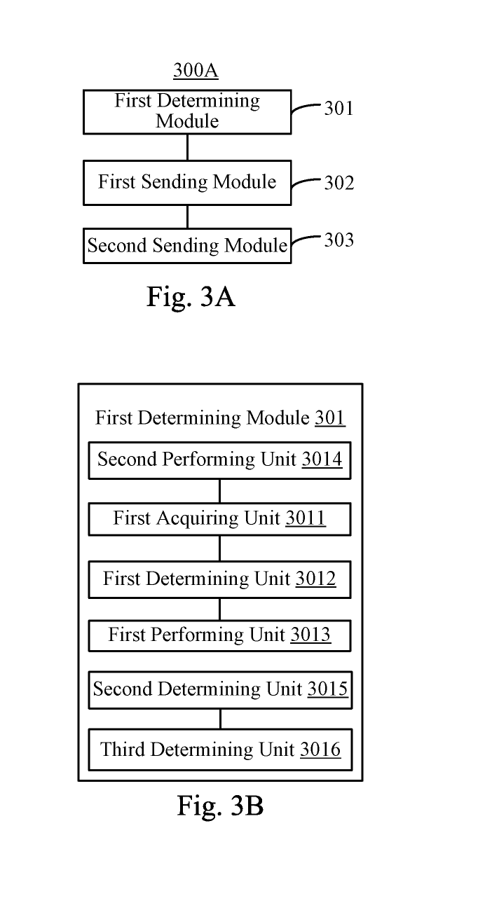

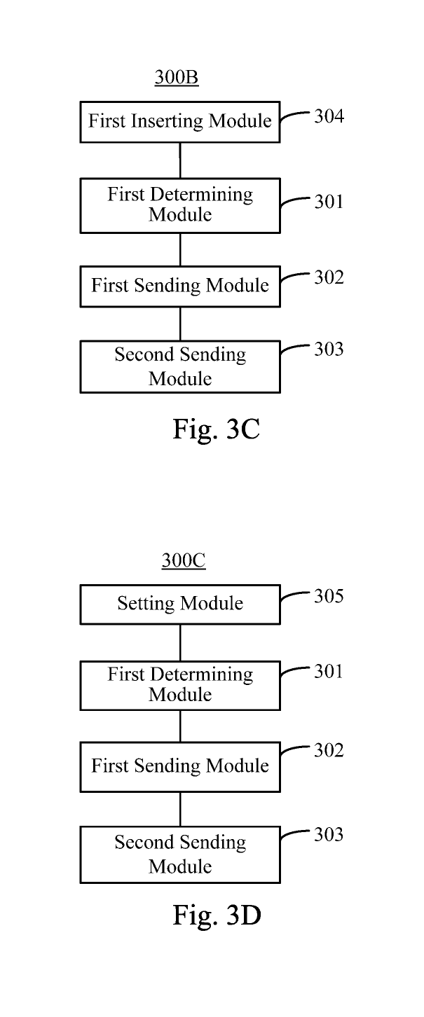

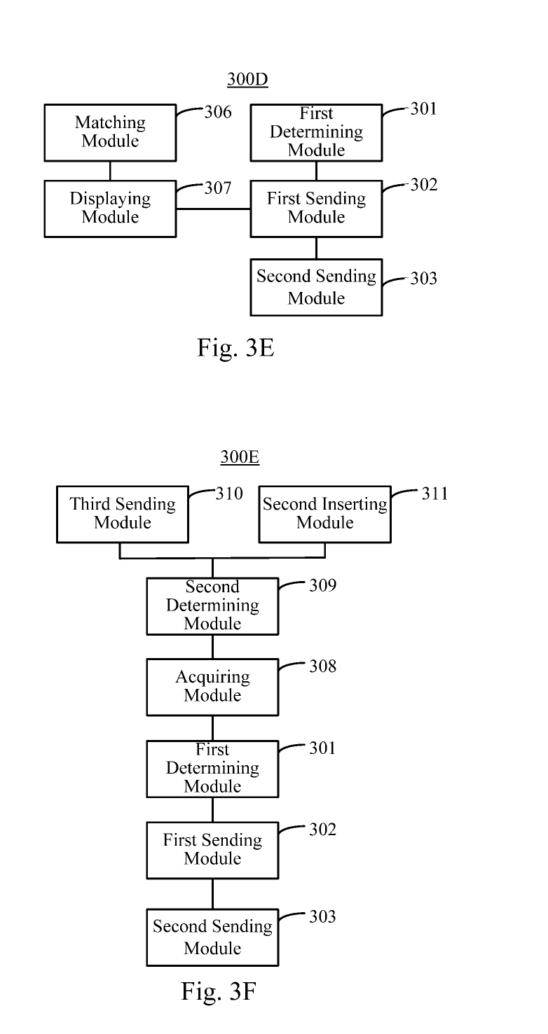

FIG. 3A is a block diagram of a device 300A for sending a message according to an exemplary embodiment. The device 300A includes a first determining module 301, a first sending module 302, and a second sending module 303. The first determining module 301 is configured to, when detecting that a triggering event with respect to a sending button in a message interface is generated, determine a condition that the triggering event satisfies. The first sending module 302 is configured to, if the first determining module 301 determines that the triggering event satisfies the common phrase sending condition, acquire a common phrase corresponding to the sending button and send the common phrase. The common phrase was preset as corresponding to the sending button. The second sending module 303 is configured to, if the determining module 301 determines that the triggering event satisfies the inputted message sending condition, acquire content in a message input box and send the content.

In some embodiments, as shown in FIG. 3B, the first determining module 301 includes a first acquiring unit 3011, a first determining unit 3012, and a first performing unit 3013. The first acquiring unit 3011 is configured to, when it is detected that the triggering event with respect to the sending button is generated, acquire a trigger operation with respect to the sending button. The first determining unit 3012 is configured to determine whether the trigger operation is the above-described preset first operation and whether the sending button corresponds to a common phrase. The first performing unit 3013 is configured to, if it is determined that the trigger operation is the preset first operation and the sending button corresponds to a common phrase, determine that the triggering event satisfies the common phrase sending condition.

In some embodiments, as shown in FIG. 3B, the first determining module 301 further includes a second performing unit 3014 configured to, if it is determined that the trigger operation is the above-described preset second operation and the sending button corresponds to a common phrase, determine that the triggering event satisfies the common phrase sending condition. In this example, the first sending module 302 is further configured to acquire the common phrase corresponding to the sending button, insert the common phrase corresponding to the sending button at a cursor position in the message input box of the message interface, and send the whole content in the message input box.

FIG. 3C is a block diagram of a device 300B for sending a message according to another exemplary embodiment. The device 300B is similar to the device 300A, except that the device 300B further includes a first inserting module 304 configured to, if it is detected that the trigger operation with respect to the sending button is performed and it is determined that the trigger operation is the above-described preset third operation, acquire the common phrase corresponding to the sending button and insert the common phrase corresponding to the sending button at a cursor position in the message input box of the message interface.

FIG. 3D is a block diagram of a device 300C for sending a message according to another exemplary embodiment. The device 300C is similar to the device 300A, except that the device 300C further includes a setting module 305 configured to acquire a common phrase through an acquiring operation performed on the message interface and set the common phrase as corresponding to the sending button.

In some embodiments, the setting module 305 includes a second acquiring unit, a third acquiring unit, and a setting unit. The second acquiring unit is configured to, if it is detected that a trigger operation with respect to a selected message in the message interface is performed, acquire the trigger operation. The third acquiring unit is configured to, if the trigger operation is an acquiring operation, acquire the selected message as a common phrase. The setting unit is configured to set the common phrase as corresponding to the sending button.

In some embodiments, the setting unit is further configured to, if the sending button corresponds to an existing common phrase, replace the existing common phrase corresponding to the sending button with the acquired common phrase or set both the acquired common phrase and the existing common phrase as corresponding to the sending button.

FIG. 3E is a block diagram of a device 300D for sending a message according to another exemplary embodiment. The device 300D is similar to the device 300A, except that the device 300D further includes a matching module 306 and a displaying module 307. The matching module 306 is configured to, if the sending button corresponds to a plurality of common phrases, match each common phrase with a searching condition to obtain a matching degree between that common phrase and the searching condition. The searching condition includes, for example, intimacy between the user of the terminal and a message receiving party, a current time, and/or a friend group to which the message receiving party belongs. The displaying module 307 is configured to display a common phrase with the highest matching degree on the sending button.

FIG. 3F is a block diagram of a device 300E for sending a message according to another exemplary embodiment. The device 300E is similar to the device 300A, except that the device 300E further includes an acquiring module 308, a second determining module 309, a third sending module 310, and a second inserting module 311. The acquiring module 308 is configured to, if the triggering event is the above-described preset fourth operation, display the plurality of common phrases corresponding to the sending button. The second determining module 309 is configured to, when it is detected that a trigger operation with respect to one of the common phrases is performed, determine a condition that the trigger operation satisfies. The third sending module 310 is configured to send the one of the common phrases if it is determined that the trigger operation is the preset first operation, or insert the one of the common phrases at a cursor position in the message input box and send the whole content in the message input box if it is determined that the trigger operation is the preset second operation. The second inserting module 311 is configured to, if it is determined that the trigger operation is the preset third operation, insert the one of the common phrases at a cursor position in the message input box.

Referring again to FIG. 3B, in some embodiments, the first determining module 301 further includes a second determining unit 3015 and a third determining unit 3016. The second determining unit 3015 is configured to determine whether content has been inputted to the message input box of the message interface before the triggering event is generated and determine whether the sending button corresponds to a common phrase. If it is determined that content has been inputted to the message input box before the triggering event is generated and the sending button does not correspond to any common phrase, the second determining unit 3015 determines that the triggering event satisfies the inputted message sending condition. The third determining unit 3016 is configured to determine whether the trigger operation performed on the sending button is the normal operation and determine whether content has been inputted to the message input box. If it is determined that the trigger operation is the normal operation and content has been inputted to the message input box, the third determining unit 3016 determines that the triggering event satisfies the inputted message sending condition.

According to the present disclosure, there is provided a device for sending a message, including a processor and a memory storing instructions executable by the processor. The instructions, when executed by the processor, cause the process to perform a method consistent with the present disclosure, such as one of the exemplary methods described above.

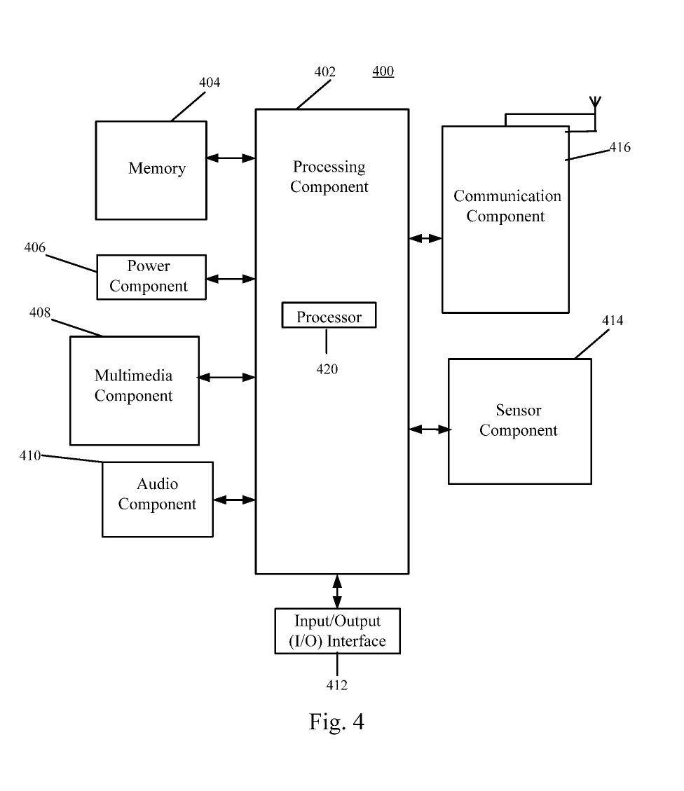

FIG. 4 is a block diagram illustrating a device 400 for sending a message according to another exemplary embodiment of the present disclosure. For example, the device 400 may be a mobile phone, a computer, a digital broadcast terminal, a messaging device, a gaming console, a tablet, a medical device, exercise equipment, a personal digital assistant, or the like.

Referring to FIG. 4, the device 400 includes one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the device 400, such as the operations associated with display, telephone calls, data communications, camera operations, and recording operations. The processing component 402 may include one or more processors 420 to execute instructions to perform all or part of the steps in the above described methods. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, video, etc. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the device 400. The power component 406 may include a power management system, one or more power sources, and any other components associated with the generation, management, and distribution of power in the device 400.

The multimedia component 408 includes a screen providing an output interface between the device 400 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 408 includes a front camera and/or a rear camera. The front camera and the rear camera may receive an external multimedia datum while the device 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 includes a microphone configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide status assessments of various aspects of the device 400. For instance, the sensor component 414 may detect an open/closed status of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communication, wired or wirelessly, between the device 400 and other devices. The device 400 can access a wireless network based on a communication standard, such as WiFi, 2G, 3G, or 4G, or a combination thereof. In one exemplary embodiment, the communication component 416 receives a broadcast signal or broadcast associated information from an external broadcast management system via a broadcast channel. In one exemplary embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, and other technologies.

In exemplary embodiments, the device 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing methods consistent with the present disclosure, such as the above described exemplary methods.

In exemplary embodiments, there is also provided a non-transitory computer-readable storage medium including instructions, such as included in the memory 404, executable by the processor 420 in the device 400, for performing a method consistent with the present disclosure, such as one of the above-described exemplary methods. For example, the non-transitory computer-readable storage medium may be a ROM, a RAM, a CD-ROM, a magnetic tape, a floppy disc, an optical data storage device, or the like.

According to the present disclosure, a user only needs to perform one operation to quickly send a common phrase to a receiving party. Thus, message sending efficiency can be improved and messages can be sent quickly. Moreover, the user can choose one of several message sending manners. For example, the user can choose to directly send the common phrase or to send content in a message input box. Therefore, the flexibility in sending messages is increased.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for sending a message from a terminal, comprising:
detecting a triggering event with respect to a sending button in a message interface of the terminal;
determining a condition that the triggering event satisfies;
if the determined condition that the triggering event satisfies is a first condition for sending a common phrase, acquiring a corresponding common phrase corresponding to the sending button and sending the corresponding common phrase; and
if the determined condition that the triggering event satisfies is a second condition for sending an inputted message, acquiring content in a message input box in the message interface and sending the content.

2. The method of claim 1, wherein determining the condition that the triggering event satisfies includes:
acquiring a trigger operation of the sending button that generates the trigger event; and
if the trigger operation is a common phrase sending operation and the sending button is associated with an existing common phrase, determining that the triggering event satisfies the first condition and the existing common phrase is the corresponding common phrase.

3. The method of claim 2, wherein:
determining the condition that the triggering event satisfies further includes:
if the trigger operation is a common phrase inserting and sending operation, and the sending button is associated with an existing common phrase, determining that the triggering event satisfies the first condition and the existing common phrase is the corresponding common phrase, and
acquiring and sending the corresponding common phrase includes:
acquiring the existing common phrase;
inserting the existing common phrase at a cursor position in the message input box; and
sending an entire content in the message input box.

4. The method of claim 1, further comprising:
acquiring a trigger operation of the sending button that generates the triggering event;
determining the trigger operation is an inserting operation;
acquiring the corresponding common phrase; and
inserting the corresponding common phrase at a cursor position in the message input box.

5. The method of claim 1, further comprising:
acquiring a candidate common phrase through an acquiring operation performed on the message interface; and
setting the candidate common phrase as the corresponding common phrase.

6. The method of claim 5, wherein acquiring the candidate common phrase includes:
detecting an operation with respect to a selected message in the message interface; and
if the detected operation is the acquiring operation, acquiring the selected message as the candidate common phrase.

7. The method of claim 5, wherein setting the candidate common phrase as the corresponding common phrase includes, if the sending button is associated with an existing common phrase:
replacing the existing common phrase with the candidate common phrase; or
setting both the candidate common phrase and the existing common phrase as corresponding common phrases corresponding to the sending button.

8. The method of claim 1, further comprising, if the sending button is associated with a plurality of existing common phrases:
matching the existing common phrases with a searching condition to obtain matching degrees between the existing common phrases and the searching condition, the searching condition including at least one of intimacy between a user of the terminal and a message receiving party, a current time, or a friend group to which the message receiving party belongs; and
displaying an existing common phrase with a highest matching degree on the sending button.

9. The method of claim 8, further comprising:
displaying the plurality of existing common phrases in response to a displaying operation;
detecting a trigger operation performed on one of the existing common phrases;
if the trigger operation is a common phrase sending operation, sending the one of the existing common phrases;
if the trigger operation is a common phrase inserting and sending operation, inserting the one of the existing common phrases at a cursor position in the message input box and sending an entire content in the message input box; and
if the trigger operation is a common phrase inserting operation, inserting the one of the existing common phrases at the cursor position in the message input box.

10. The method of claim 1, wherein determining the condition that the triggering event satisfies includes determining that the triggering event satisfies the second condition if:
content has been inputted to the message input box before the triggering event is generated and no existing common phrase corresponds to the sending button; or
the trigger operation is an inputted message sending operation and content has been inputted to the message input box.

11. A terminal comprising:
a processor; and
a memory storing instructions that, when executed by the processor, cause the processor to:
detect a triggering event with respect to a sending button in a message interface of the terminal;
determine a condition that the triggering event satisfies;
if the determined condition that the triggering event satisfies is a first condition for sending a common phrase, acquire a corresponding common phrase corresponding to the sending button and send the corresponding common phrase; and
if the determined condition that the triggering event satisfies is a second condition for sending an inputted message, acquire content in a message input box in the message interface and send the content.

12. The terminal of claim 11, wherein the instructions further cause the processor to:
acquire a trigger operation of the sending button that generates the trigger event; and
if the trigger operation is a common phrase sending operation and the sending button is associated with an existing common phrase, determine that the triggering event satisfies the first condition and the existing common phrase is the corresponding common phrase.

13. The terminal of claim 12, wherein the instructions further cause the processor to:
if the trigger operation is a common phrase inserting and sending operation, and the sending button is associated with an existing common phrase, determine that the triggering event satisfies the first condition and the existing common phrase is the corresponding common phrase;
acquire the existing common phrase;
insert the existing common phrase at a cursor position in the message input box; and
send an entire content in the message input box.

14. The terminal of claim 11, wherein the instructions further cause the processor to:
acquire a trigger operation of the sending button that generates the triggering event;
determine the trigger operation is an inserting operation;
acquire the corresponding common phrase; and
insert the corresponding common phrase at a cursor position in the message input box.

15. The terminal of claim 11, wherein the instructions further cause the processor to:
acquire a candidate common phrase through an acquiring operation performed on the message interface; and
set the candidate common phrase as the corresponding common phrase.

16. The terminal of claim 15, wherein the instructions further cause the processor to:
detect an operation with respect to a selected message in the message interface; and
if the detected operation is the acquiring operation, acquire the selected message as the candidate common phrase.

17. The terminal of claim 15, wherein the instructions further cause the processor to, if the sending button is associated with an existing common phrase:
replace the existing common phrase with the candidate common phrase; or
set both the candidate common phrase and the existing common phrase as corresponding common phrases corresponding to the sending button.

18. The terminal of claim 11, wherein the instructions further cause the processor to, if the sending button is associated with a plurality of existing common phrases:
match the existing common phrases with a searching condition to obtain matching degrees between the existing common phrases and the searching condition, the searching condition including at least one of intimacy between a user of the terminal and a message receiving party, a current time, or a friend group to which the message receiving party belongs; and
display an existing common phrase with a highest matching degree on the sending button.

19. The terminal of claim 18, wherein the instructions further cause the processor to:
display the plurality of existing common phrases in response to a displaying operation;
detect a trigger operation performed on one of the existing common phrases;
if the trigger operation is a common phrase sending operation, send the one of the existing common phrases;
if the trigger operation is a common phrase inserting and sending operation, insert the one of the existing common phrases at a cursor position in the message input box and send entire content in the message input box; and
if the trigger operation is a common phrase inserting operation, insert the one of the existing common phrases at the cursor position in the message input box.

20. The terminal of claim 11, wherein the instructions further cause the processor to determine that the triggering event satisfies the second condition if:
content has been inputted to the message input box before the triggering event is generated and no existing common phrase corresponds to the sending button; or
the trigger operation is an inputted message sending operation and content has been inputted to the message input box.
